(19) United States
(12) Patent Application Publication
(10) Pub. No.: US 2026/0365443 A1
(43) Pub. Date: Nov. 19, 2026

(54) SYSTEM FOR HANDLING AND TRANSPORTING LOOSE PARTS FOR MANUFACTURE OF WIRE HARNESSES AND ELECTRICAL CONNECTORS

(71) Applicant: C. DAVIS SYSTEMS & SOFTWARE, L.L.C., Portland, OR (US)

(72) Inventors: Steven William Will, Portland, OR (US); David Lawrence Heifetz, Portland, OR (US)

(21) Appl. No.: 18/631,492

(22) Filed: Apr. 10, 2024

(51) Int. Cl. B65G 43/08; B65G 47/12; B65G 47/24; B65G 51/04; G06T 7/70; H04N 23/54; F16K 11/044; G06F 3/04842; G06N 3/0895; G06N 3/098; H01R 43/048; H04N 23/55

(52) U.S. Cl. CPC B65G 43/08; B65G 47/12; B65G 47/24; B65G 51/04; G06T 7/70; H04N 23/54; B65G 2203/0225; B65G 2203/041; F16K 11/044; G06F 3/04842; G06N 3/0895; G06N 3/098; G06T 2207/20081; H01R 43/048; H04N 23/55

(57) ABSTRACT

The system comprises a vibratory bowl fed modular parts handling escapement mechanism featuring an oversized escapement module, which includes a parts passageway extending linearly from the parts bowl to a shuttle compartment and the shuttle compartment including a set of multiple parts tube mounting holes. A shuttle located inside the shuttle compartment having a parts cavity parallel to the parts passageway and at least one optical sensor configured to measure the presence/absence, and orientation of a subject part in the shuttle. The system comprises multiple parts tubes, which use pneumatic pressure to transport the subject part through one of the multiple parts tubes away from the system. A first parts tube of the multiple parts tubes transports the subject part when the subject part has a first orientation, and a second parts tube of the multiple parts tubes transports the subject part when the subject part has a second orientation.

### BACKGROUND

This disclosure relates to handling of loose electrical contacts, sealing plugs and other similar parts in the manufacture of wire harnesses and connectors. The systems that perform these tasks are typically configured for a specific contact or other specialized part and make use of the known dimensions, weight distribution, and other features of that part to mechanically sort and otherwise handle and feed the part for a secondary process: a contact to be crimped to a wire or a contact or plug inserted into a connector either in response to an operator-initiated signal or automatically.

Small changes in the physical dimensions of a contact, sealing plug or other similar part typically require extensive reworking of the mechanical part handling and feeding system that are both expensive and time consuming, often requiring redeveloping the entire mechanical system. The extensive rework is a response to a high degree of precision that is required for the resultant part handling and feeding system to feed and cycle reliably. Due to high parts costs and efficiency requirements in various industrial applications, the degree of reliability must be exceedingly high for the system to have functional value.

Delivery mechanisms for wire termination and contact and seal plug insertion include (among others) magazine feeding, robot arm delivery, and pneumatic tubes. In existing embodiments, each of these mechanisms are designed and manufactured to make use of particular physical features of the parts to orient and otherwise handle and feed the parts for processing in a secondary operation. This process is thus reliant on those particular physical features and change over to a new part often requires a new mechanism built to handle that part.

### BRIEF DESCRIPTION OF THE DRAWINGS

Detailed descriptions of implementations of the present invention will be described and explained through the use of the accompanying drawings.

FIG. 1 illustrates an isometric view of an embodiment of a full assembly of the system.

FIG. 2 illustrates a top-down view of an embodiment of the parts bowl and the escapement module.

FIG. 3 illustrates an isometric view of an embodiment of the escapement module and optical sensor.

FIG. 4a is a screen shot that illustrates an embodiment of a program interface displaying the output of a first measurement taken by the system.

FIG. 4b is a screen shot that illustrates an embodiment of a program interface displaying the output of a second measurement taken by the system.

FIG. 4c is a screen shot that illustrates an embodiment of a program interface displaying the output of a third measurement taken by the system.

FIG. 4d is a screen shot that illustrates an embodiment of a program interface displaying the output of a fourth measurement taken by the system.

FIG. 5 illustrates an exploded isometric view of an embodiment of the escapement module and parts bowl.

FIG. 6a illustrates a sectioned top-down view of an embodiment of the escapement module.

FIG. 6b illustrates a sectioned top-down view of an embodiment of the escapement module.

FIG. 7 illustrates an isometric view of the parts bowl.

FIG. 8 illustrates an isometric view of an embodiment of the receiving block of the twinfire module.

FIG. 9 illustrates an exploded isometric view of the twinfire module.

FIG. 10a illustrates a sectioned top-down view of an embodiment of the twinfire module.

FIG. 10b illustrates a sectioned top-down view of an embodiment of twinfire module.

FIG. 11 illustrates a flow chart of an embodiment of parts handling of the system.

FIG. 12 illustrates a flow chart of an embodiment of parts delivery of the system.

FIG. 13 is a block diagram illustrating an example ML system in accordance with one or more embodiments.

FIG. 14 is a block diagram that illustrates components of a computing device.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. In particular, the escapement and twinfire modules are modular components and can be made in various sizes to accommodate a wide variety of differently sized parts. Accordingly, while specific implementations are shown in the drawings, the technology is amenable to various modifications and wide variety of applications.

### DETAILED DESCRIPTION

The disclosed technology relates to a system and method of handling of loose electrical contacts (contact), sealing plugs (plug) and other similar parts (part) to enable a “universal” system capable of automatically handling, feeding and crimping a significant range of contacts to an electrical wire (wire). This same method of automatic handling and feeding also has great utility in handling and feeding contacts and plugs for insertion into connectors, as well as other similar applications in the manufacture of wire harnesses. In the crimping application, the contact is crimped to the wire end to allow the wire to transfer electricity or data to another wire or a device. In other applications the contact or plug is inserted into a connector to seal a cavity or for other reasons. The system allows for different loose parts to be easily processed through the same handling and feeding system, reducing the costs and downtime associated with developing and integrating a new part handling and feeding system for each part.

For example, the system handles and feeds any part similarly shaped and sized to a contact or plug and transports the component to a remote location for a secondary process (e.g., a crimp head or an inserter head). Traditional mechanical part handling and feeding systems only accommodate one contact type or require development of multiple contact-specific parts to function with a new contact type, causing extensive costs and downtime when a different part is required. More versatile extant systems like robot arms coupled with optical systems and light tables are very flexible and can handle a wide variety of parts, but also run at very slow rate as compared to both traditional mechanical handling and feeding systems and the novel system here disclosed Embodiments of the disclosed methods and systems are implemented in multiple configurations including benchtop, user-operated systems, and larger more complicated, fully automated systems.

Regardless of configuration, the universal parts handling system reconfigures for any contact, sealing plug or other part that can pass through the elements of the system in a tail or tip orientation, and can be placed on a tabletop. The system enables a wide variety of loose contacts, plugs and other loose parts to be handled and transmitted with little to no modifications. Additionally, the various components of the disclosed system are modular and can be changed out quickly and easily for other modules which can accommodate different size ranges of loose parts.

In some embodiments, the system includes a parts bowl configured to store multiple loose contacts. In one embodiment, the parts bowl can be any shape capable of storing the loose contacts. In another embodiment, the vibratory parts bowl includes a storage compartment with a circular base and an exterior wall extending radially around the outer diameter of the circular base. The parts bowl also includes a parts track configured to transport the contact from the storage compartment to a singulator. For example, a parts track is circumscribed about an inner circumference. The parts track extends helically around the inner circumference from the circular base to the sorting and orientation mechanism (escapement module), located near the top surface of the exterior wall.

The system includes an escapement module configured to facilitate the handling of loose parts, determine orientation of the part and transport the part for further processing. Contacts are conveyed to a crimp head module by being air blown through a parts tube, plugs are conveyed in a similar manner to an inserter head, etc. In some embodiments, the escapement module is tangentially mounted to the outer surface of the parts bowl. The escapement module includes the singulator, which isolates individual contacts for handling. The singulator is a parts passageway configured to transport the part from the parts track to a first shuttle in a single file queue of individuated parts. The parts passageway extends linearly from a first end of the singulator to a first shuttle compartment. The first shuttle compartment is adjacent to two parts tubes, where each parts tube is mounted axially offset and parallel from the other. In one embodiment, the first set of parts tubes mounting holes are coaxially aligned about the same single axis. In some embodiments, the escapement module includes an airgate. The airgate mounts above the singulator. The airgate is configured to remove the part from the singulator using pneumatic pressure. The airgate returns parts on the parts track or singulator to the bowl based on an indication from one or more sensors, or commands from the controller. For example, where the sensor indicates that an incorrect contact is in the singulator, or that multiple contacts are positioned too close together in the singulator, or to allow the controller to prevent further flow of parts through the escapement module for whatever reason. Further, in some embodiments, the airgate removes the part based on a detected orientation.

The escapement module includes a first shuttle located inside the first shuttle compartment. In one embodiment, the first shuttle includes a parts cavity parallel to the parts passageway. The first shuttle is configured to axially translate along a bottom surface of the first shuttle compartment. In one embodiment, the first shuttle can have multiple positions. In the first position, the first shuttle's parts cavity is coaxially aligned with the single axis of the singulator. In the second position, the first shuttle's parts cavity is coaxially aligned with a single axis of the multiple parts tubes. Moving the first shuttle from the first position to the second position transports the contact from being in line with the singulator to being in line with the parts tubes.

The escapement module can include at least one optical sensor configured to measure the orientation of the part when the part is in the escapement shuttle/first shuttle. For example, measuring the orientation of the contact allows a controller to determine which of the multiple parts tubes to transport the contact in. For example, the optical sensor can be a camera, fiber optic sensor, or any sensor capable of measuring the presence or absence of a contact, and the orientation of a contact via trained data models based on readings from the sensor. The sensor works in conjunction with a machine learning (ML) model (e.g., a computer vision model), which is trained to determine the presence/absence of a contact, its orientation, and whether the shuttle is clear of obstructions and can be safely moved to another position without jamming on a part. The ML model can be trained on a new part type by a user in a few minutes or hours. During training, a user inputs training data relating to the new contact or causes the system to take measurements of the new part in multiple orientations. Unlike traditional systems that can require development of novel mechanism to accommodate a new part type due to the need for substantial, physical modifications, the camera system only needs to be trained on the new part type with the correctly sized pre-built escapement and other modules fitted, allowing a user to switch to a new contact type quickly. Once the system has been trained on a particular part, that part's profile is saved in a data storage system and change out for future use of that part. Said future use is accomplished by loading that profile without need for retraining. One reason for the improvement is that the modular escapement mechanism, parts passageway, shuttle and parts tubes are sized such that a range of contact shapes and sizes can fit through an individual escapement module. The pathways for parts in the system are thus oversized to enable transit of most any loose part used in the manufacture of wire harnesses. A larger and smaller range of parts, or those requiring more specialized handling, can be accommodated by switching out the escapement module and the twinfire module with one of a different size or configuration. The system thus relies on identification of orientation by the sensor and ML model to determine how next to process the contact.

The escapement module includes the multiple parts tubes. Each of the multiple parts tubes has a first end coaxially aligned and contiguous to one of the parts tube mounting holes of the first set of parts tube mounting holes. Each parts tube is configured to transport the contact or other part from the escapement module to a crimp head module or other mechanism for further processing.

In some embodiments, the system includes a twinfire module configured to receive the part from the escapement module and direct the part to a secondary process like a crimp head, inserter head, or other auxiliary applicator. The twinfire module is a device that directs pneumatic force through a selected parts tube based on a detected part orientation and then receives the part in a corresponding opposite parts tube. In such embodiments, the escapement module pneumatically transmits the part down one of multiple parts tubes to the twinfire module, and the combination of these mechanisms enable a part arriving through the parts passageway in either orientation to be delivered in the proper orientation for further processing, e.g., in a crimping application the contact would be fed to the crimp head with the wire barrel forward enabling wire termination. For wire termination applications, in one embodiment, the twinfire module is separate from an auxiliary applicator. In another embodiment, the crimp head module incorporates the twinfire module.

In some embodiments, the twinfire module includes a shuttle and a forked parts passageway. The shuttle alternates positions to enable flow through one of the multiple parts tubes at a time that correspond with the detected handling needs of the subject part. For example, each second end of the multiple parts tube attaches to a different parts tube mounting hole. The forked passageway merges the multiple parts tubes into a single passageway. The single remaining passageway delivers the part to an auxiliary applicator, such as a crimp head.

The crimp head module includes a crimping mechanism configured to crimp the contact to the wire. In some embodiments, wire guide funnels are mounted to the crimp head module. In some embodiments, an adjustable depth contact stopper is mounted to the crimp head module.

The system includes a controller that is configured to control the system. For example, the controller can determine a part's orientation based on the optical sensor's measurement. In another example, the controller can control the position of the shuttle(s) based on presence or absence of a part, the determined orientation of that part, and control various other mechanisms based other datum derived from various sensors. In a crimping application, the controller, combined with the escapement module and crimp head module, allows the system to accommodate various contact types and easily switch between the contact types. In one embodiment, the system includes a series of pneumatic valves and cylinders (pneumatic module). The controller actuates valves which in turn actuate cylinders that move the shuttles from position to position, power the actuation of a crimp mechanism and associated funnels or contact stopper, actuate an inserter head, as well as actuating other mechanisms in the system. The controller actuated valves also provide pressurized air to transport the contact along the appropriate parts tubes, and to operate airgates when present.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Loose Parts Handling and Transport System Configured for Crimping of Electrical Contacts

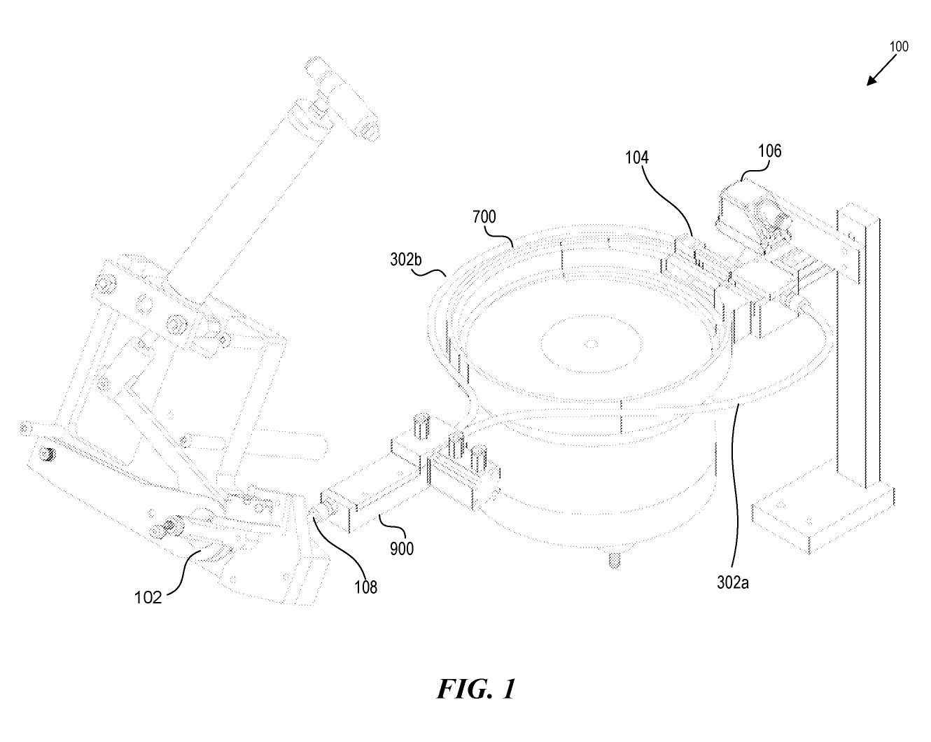

FIG. 1 illustrates an isometric view of an embodiment of a working assembly 100 of the system configured for wire termination and thus for handling and crimping electrical contacts. The system includes parts bowl 700, which is configured to store multiple loose parts, in this example, electrical contacts. Parts bowl 700 employs vibratory force to transit contacts up the parts bowl's parts track to an escapement module 104. Escapement module 104 is configured to position the contacts in a single file line with spacing between the parts to allow them to be handled individually reducing the incidence of system jamming and other failure condition. Escapement module 104 directs contacts one at a time past optical sensor 106. Optical sensor 106 is configured to measure the presence or absence of a specific type of contact and/or the orientation of the contact as the contact passes along escapement module 104. After measuring the presence of and orientation of the contact and verifying that the shuttle is clear of obstructions, a controller causes the contact to be transported using pressurized air (pneumatic force) along either parts tube 302a or 302b. When the contact is measured to have a first orientation, the controller causes the contact to be transported along parts tube 302a. When the contact is measured to have a second orientation, the controller causes the contact to be transported along parts tube 302b. In some embodiments, optical sensor 106 is configured to verify that the correct type of contact has arrived at the escapement module.

The contact is transported to a twinfire module 900. Twinfire module 900 is configured to merge parts tube 302a and parts tube 302b into a single parts tube 108. In a crimping application like FIG. 1, the twinfire module allows crimp head module 102 to receive the contact in the same orientation (wire barrel forward) no matter which orientation the contact had in escapement module 104, which enables the secondary operation of wire termination performed by the crimp head. Parts tube 108 is connected to crimp head module 102. Crimp head module 102 is configured to crimp the contact onto a wire end. For example, Crimp head module 102 can be fitted with a wire guide funnel assembly or a contact stopper. When fitted with a wire guide funnel assembly, a wire is inserted into the wire guide funnel which aligns the wire to the wire barrel of the contact and enables easy and rapid insertion of the wire. After inserting wire into the contact, the crimp head is pneumatically actuated to crimp the contact to the wire and create a robust electrical connection. Other secondary processing methods, such as seal plug insertion will have a different mechanism replacing 102 but will be fed loose parts in a similar manner.

While the depicted embodiment is of a benchtop, user-operated wire terminating machine, this flexible method of handling a wide variety of loose contacts, plugs and other parts are applicable to fully automated wire processing machines, and other applications in the manufacture of wire harnesses, like seal plug and dummy contact insertion into connectors. Depicted elements are modular in that across various embodiments, elements are not present, replaceable or substitutable. For example, in some embodiments the twinfire module 900 is removed and an airgate pushes each contact that is not detected in a preferred orientation back into the parts bowl 700. In some embodiments the various modular elements are substantially larger or smaller to accommodate a different size range of parts.

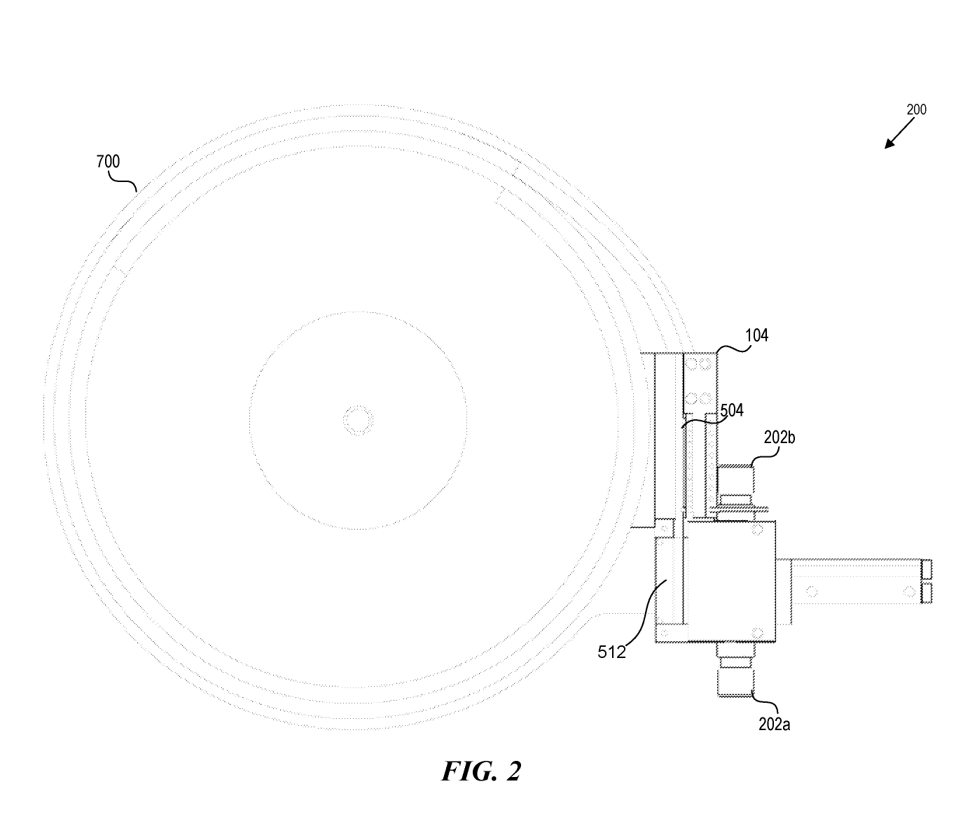

FIG. 2 illustrates a top-down view of an embodiment 200 of parts bowl 700 and escapement module 104. Escapement module 104 is tangentially mounted to the exterior of parts bowl 700. Parts bowl 700 includes a flat milled pocket which escapement module 104 is mounted to. The milled pocket allows escapement module 104 to form a tangent line that is in line with the parts track of parts bowl 700. Mounting escapement module 104 in this manner causes parts tube connectors 202a and 202b to be parallel to the tangent line perpendicular to the radius of parts bowl 700. Positioning parts tube connectors 202a and 202b in this manner mitigates the parts tubes from intersecting with parts bowl 700. Parts that transition from the parts bowl 700 to the escapement module 104 travel along the parts passageway 504 to the escapement shuttle 512. The escapement shuttle 512 slides within the escapement module 104 to align with the parts tube connectors 202a and 202b. At that stage the contact is similarly aligned and is ready to transit through parts tubes.

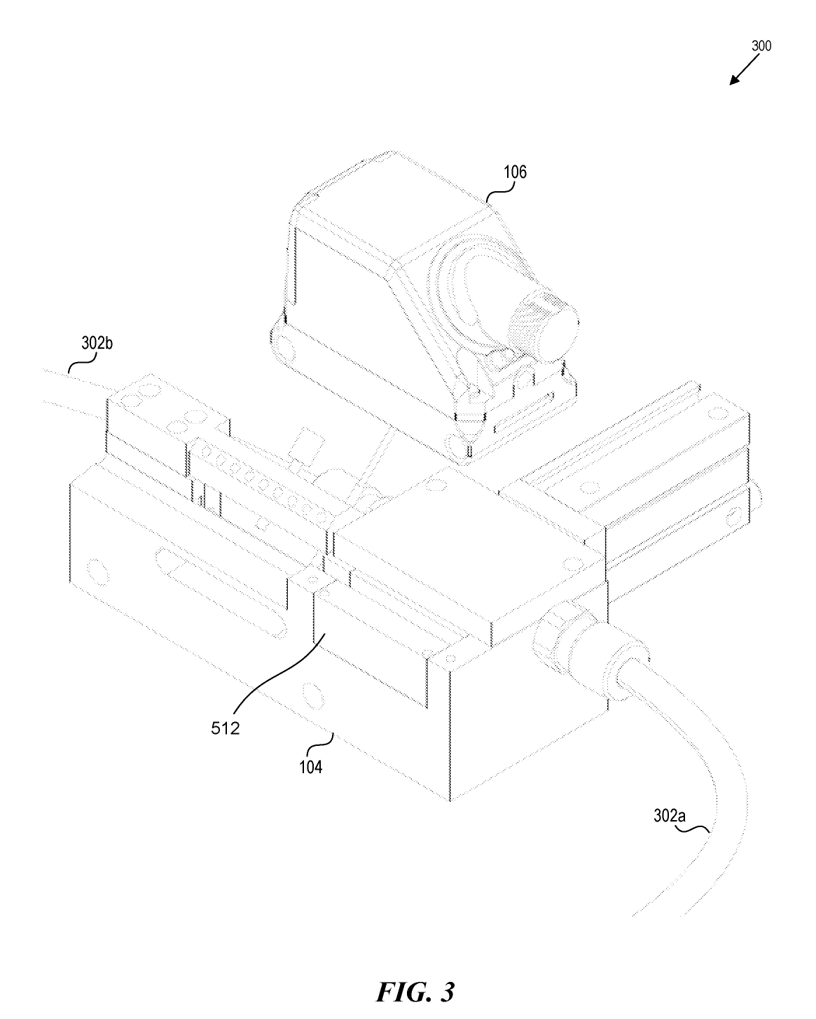

FIG. 3 illustrates an isometric view of an embodiment 300 of the escapement module 104 and optical sensor 106. Optical sensor 106 is positioned over escapement module 104. Optical sensor 106 determines the presence/absence of a part and the orientation of the part when the part arrives under optical sensor 106. Optical sensor 106 can determine whether no contact is in escapement module 104, escapement shuttle 512, whether the part is in a first position (e.g., wire barrel first), or whether the part is in a second position (e.g., socket first). Optical sensor 106 can also determine if the shuttle is obstructed in a manner which would prevent safe actuation. For example, the leading end is in relation to the direction that the part is moving along escapement module 104 in the case of a contact, either the wire barrel or the socket leading. When the part is in the first position, the part is transported along parts tube 302a. When the contact is in the second position, the contact is transported along parts tube 302b. Embodiments of the Optical sensor 106 communicates with a visual indication when a contact is positioned below optical sensor 106, such as a flashing light, a solid light, or different colored lights. Optical sensor 106 may also be used to determine that the correct type of part has been provisioned to the system.

In some embodiments, the parts tubes are connected to the same pneumatic valve– that is, in order to blow the contact down parts tube 302a, air pressure is applied from parts tube 302b through the escapement shuttle 512 toward parts tube 302b. Conversely, to blow the contact down parts tube 302b, air pressure is applied from parts tube 302a through the escapement shuttle 512 toward parts tube 302b. This directional changed is accomplished by actuating the twinfire mechanism in conjunction with the pneumatic valve which supplies the pressurized air to blow the contact down a parts tube.

Optical sensor 106 determines the orientation of the contact using an ML model. The ML model is trained on training data containing known orientations of the contact. For example, the training data includes a plurality of data readings that are captured by the optical sensor 106 each with a labeled orientation. The training is performed on a per-part basis. That is, each part that a user intended to run through the system goes through a training process. Given the limited number of orientations (e.g., 2) and limited number of variations (e.g., positioning limited by the parts passageway 504 and/or escapement shuttle 512) there are comparatively few permutations to train for a single part. Thus, the training data need not be as voluminous as many known ML models. Training for a new contact part is a process that is measured in minutes or hours as opposed to the weeks or months required to retool a whole wire termination system for a new part. Part specific optical sensor training data can be saved in a data storage device and once the camera system has been trained on a specific part, changeover to that part is as simple as loading that part's saved profile.

Saved profiles for parts are stored in a parts library that are loaded up on request. In some embodiments a known parts database or library is pre-trained and provides a base data set. The base data set serves as a training data set for features that are not part specific such as whether there is an obstruction to the escapement shuttle 512.

In some embodiments, the optical sensor 106 is a camera. Thus, the data collected by the optical sensor 106 is visible light representations of the contact within the parts passageway 504 or escapement shuttle 512. In some embodiments, the optical sensor 106 further includes a light directed toward the contact so as to present consistent visibility conditions of visible light to collected data.

In some embodiments, the user positions the new contact type in various orientations and causes the optical sensor to capture each orientation. The ML model is then trained on the measurements, allowing the system to function with the new contact type. In some embodiments, the training data enables the ML model to determine the orientation for various contacts and components. Additionally, the training data allows the ML model to determine the orientation of part types and sizes that were not included in the training data. While not necessarily the preferred mode of operation, similarly shaped contacts may be detected accurately with existing models trained for previously evaluated contacts.

In operation, the ML model measures the orientation based on captured image data of a current contact and outputs the determined orientation to the system along with a certainty score. The ML model employs a computer vision-style input and output scheme. The current optical sensor 106 reading is provided to the ML model and an orientation is identified therefrom. The system employs subsequent parts handling using the output of the ML model against a settable threshold. In some embodiments, the output of the model is presented on a display along with a certainty score. The higher the certainty score, the more certain the ML model is about the orientation of the contact. The higher the threshold setting the more certainty that the part is oriented correctly. When the ML model detects something which is not a learned part in one of two orientations or an empty shuttle it will send an error signal to the controller. Additionally, the optical sensor and associated ML model can verify that the shuttle is clear of obstructions and can actuate without crashing into parts or debris. In some embodiments, error signals are cleared by operation of an airgate.

A controller receives a signal indicating a part is present, the determined orientation of the part, and verification that the escapement shuttle 512 is not obstructed, or an error condition. In a given embodiment, the controller causes the pneumatic system to operate, first to articulate escapement shuttle 512 to second position in-line with the parts tubes 302a and 302b, and then to and blow the part down a parts tube corresponding to the determined orientation. It is contemplated that configuring a dual parts tube/twinfire system need not be the only fashion upon which that a controller responds to an orientation determination. For example, in some embodiments, a first orientation will continue to path through the system whereas a second orientation is blown back into the parts bowl by an air gate.

The elements of the system that enable high interoperability of parts/contact handling are an oversized escapement module 104 and the optical sensor 106 communicatively coupled with a ML model and operated by a controller. The escapement module 104 being oversized enables a significant variability of contacts to pass through the system and is designed in a modular fashion to allow the easy interchange of differently sized components to handle different size ranges of parts. The optical sensor 106 and ML model enables non-contact (e.g., without touching) detection of an orientation of the contact/part as well as making other determinations that provide useful datum and inputs to the controller for handling the parts and to otherwise generally enhance the reliability and speed of the system. The controller causes remaining system elements to process the detected part accordingly. Downstream handling employs modular components for secondary processes that vary based on industrial application.

The escapement module 104 and escapement shuttle 512 are designed such that the contents of the escapement shuttle 512 are externally visible to the optical sensor 106 in one of the available shuttle positions. Observing the part by the optical sensor 106 at the last moment before the part moves to the next stage increases reliability of the system. In subsequent shuttle positions, the escapement shuttle 512 is positioned to create a sufficient seal to apply pneumatic force to the part.

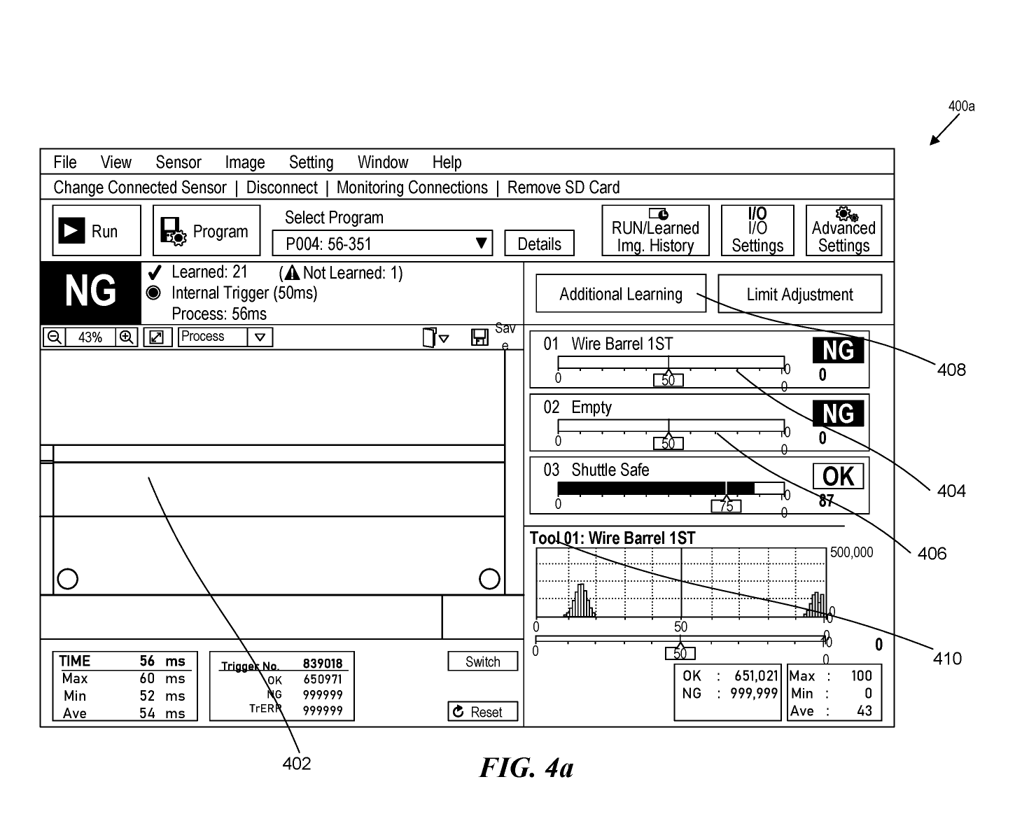

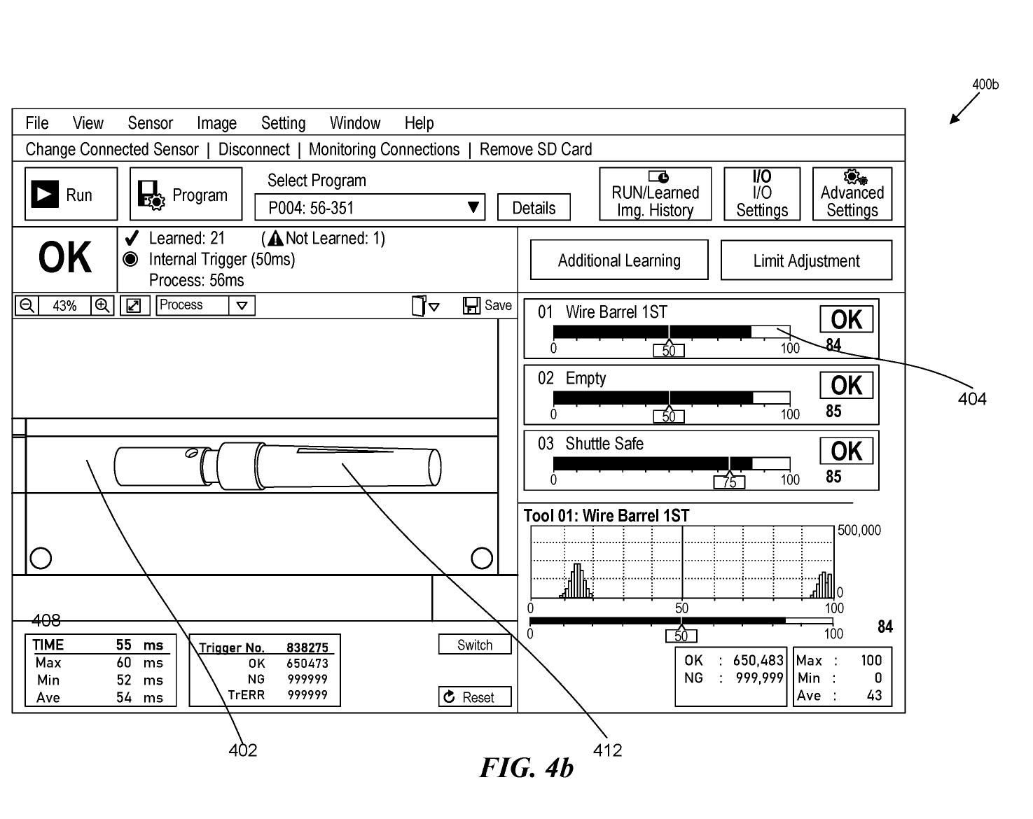

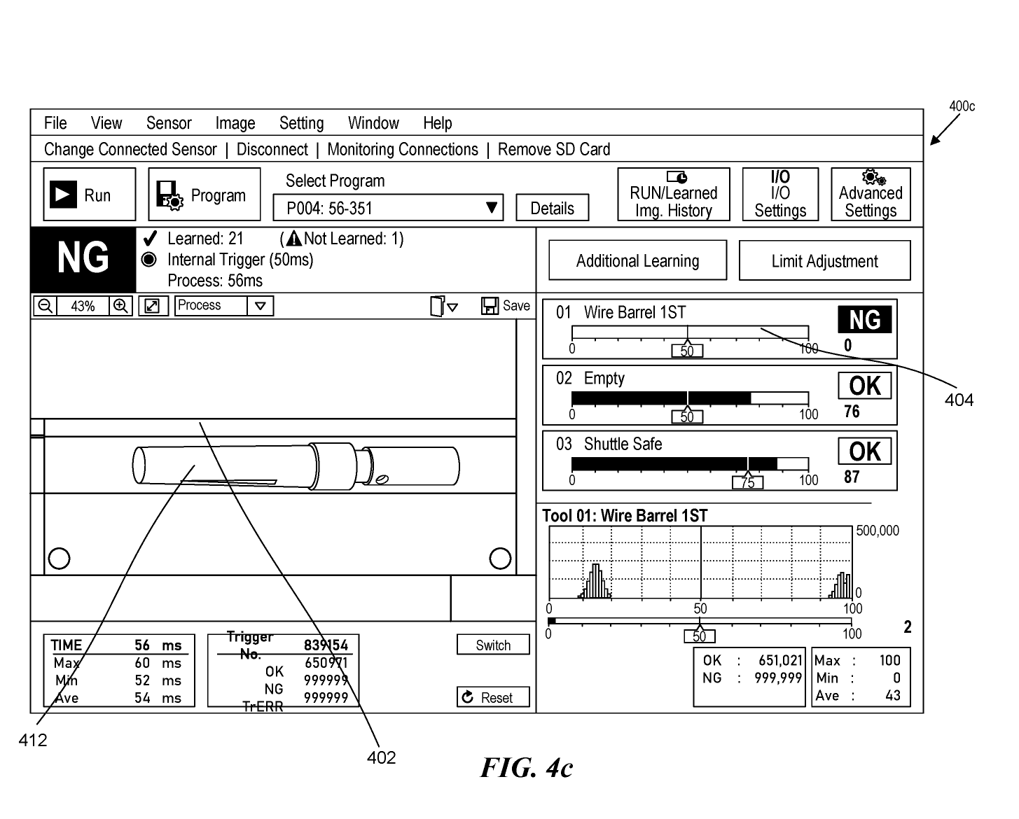

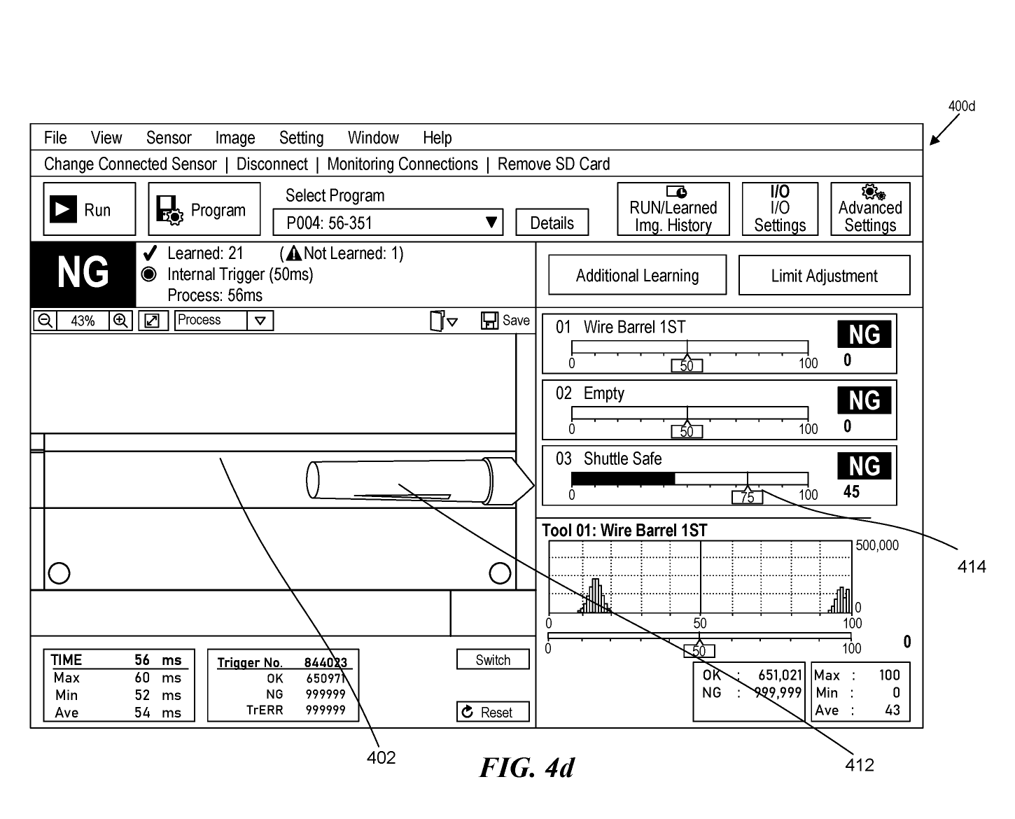

FIG. 4a is a screen shot that illustrates an embodiment of a program interface 400a displaying the output of a first measurement taken by the system. The screen shot is provided for illustrative purposes. In standard operation, a user need not view the user interface as depicted. The output data is sufficient for machine operation without being rendered for user convenience. That said, the training process for the ML model does employ a graphic user interface. In a given example, the output displays as an optical view of the escapement shuttle 402. The escapement shuttle 512 is observable in at least one position by the optical sensor 106. The availability of observation into the escapement shuttle 512 has not been a design constraint in prior art systems. Here, the escapement shuttle 512 is the last opportunity for the system to observe a part prior to acting on the part and feeding the part to the next phase of process.

The output further displays the orientation 404 and the certainty score calculated by the ML model. FIG. 4a depicts that no contact is currently present in the escapement shuttle 512. That the shuttle is empty is measured with a specific confidence score for whether the shuttle is empty 406 In the depicted embodiment, the output displays “empty” based on a 0% confidence that a part is present in the shuttle.

In some embodiments, the program interface 400a includes an additional learning button 408, which allows a user to train or retrain the ML model with additional images of the current contact to improve the accuracy of determinations made by the ML model. Additionally, the program interface 400a displays the program that is running. For example, program interface 400a indicates that "Program P004: 56-351" is running, showing that the system is currently configured to handle and feed MILSPEC electrical contact M39029/56-351. Trained programs are saved to enable the operators to quickly change configurations without re-training and allow machines to ship with a large library of pre-trained programs. When paired with the correct escapement mechanism, this facilitates the machine being able to feed a range of commonly used parts without having to perform training.

FIG. 4b is a screen shot that illustrates an embodiment of a program interface 400b displaying the output of a second measurement taken by the system. The output displays an optical view of the escapement shuttle 402 and shows that an imaged part 412 is currently present in the escapement shuttle 512. The output further displays the orientation 404 and the certainty score calculated by the ML model. In the depicted embodiment, the output displays “wirebarrel1st” with a certainty score of 84%. Based on current model settings, the confidence score of 84% is sufficient for the system to operate based on the information that the wire barrel is oriented forward. In some embodiments, the ML model can have a predetermined certainty score cutoff. For example, a certainty score below a threshold value such as 75, 70, 60, or 50 leads to the system employing use of the airgate and pneumatic pressure to eject the contact from the escapement model.

FIG. 4c is a screenshot that illustrates an embodiment of a program interface 400c displaying the output of a third measurement taken by the system. The output displays an optical view of the escapement shuttle 402 and shows that an imaged contact 412 is currently present in the escapement shuttle 512. The output further displays the orientation 404 and the certainty score calculated by the ML model. In the current embodiment, the output displays 0% of being wire barrel 1^{st}, which means that the system is certain (100%) that the part is positioned in the shuttle socket first.

FIG. 4d is a screen shot that illustrates an embodiment of a program interface 400d displaying the output of a fourth measurement taken by the system. The output displays an optical view of the escapement shuttle 402 and shows that an imaged contact 412 is partially in the escapement shuttle 512. The output further displays the shuttle status 414 and the certainty score calculated by the ML model. Specifically, the model has determined that it is 45% confident that the escapement shuttle 512 is safe to actuate. 45% confidence is low, and below the configured threshold. The reason for the poor confidence is that the imaged part 412 is partially in the escapement shuttle 512 and partially out of the escapement shuttle 512. The position of the imaged part 412 will lead to the shuttle jamming if it is to actuate.

In some embodiments, the system throws an error signal which indicates that an operator should clear the shuttle. In some embodiments, the system employs an airgate to blow the part (or any other problematic debris) out of the shuttle or activates the vibratory bowl to attempt to move the part further intro the shuttle.

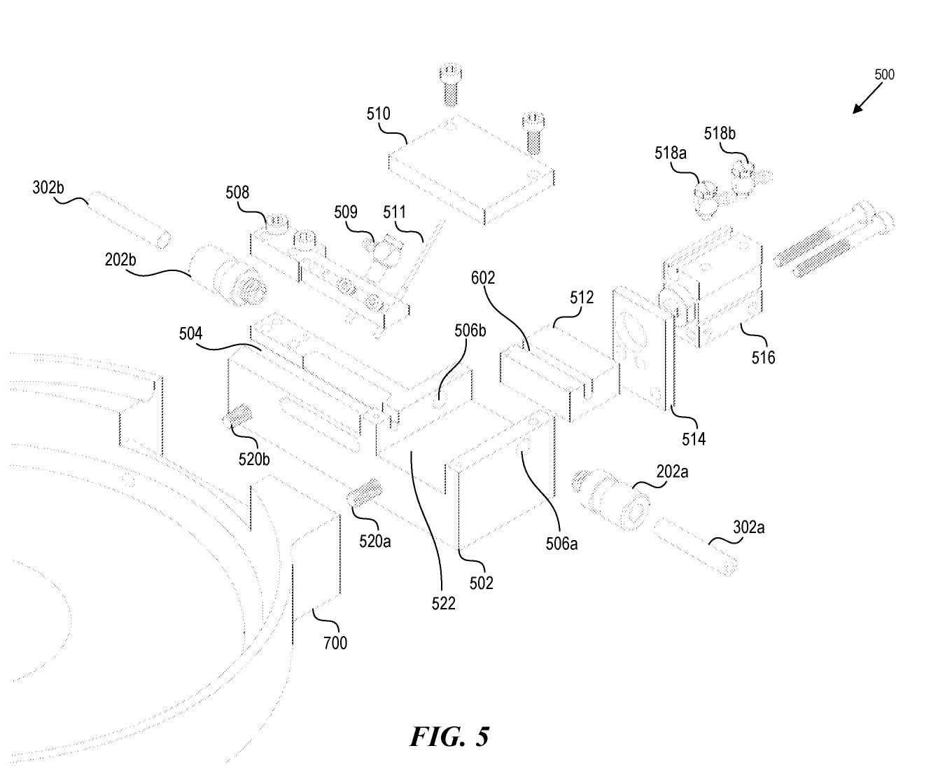

FIG. 5 illustrates an exploded isometric view of an embodiment 500 of escapement module 104 and parts bowl 700. The escapement module 104 includes an escapement block 502. Escapement block 502 can mount to parts bowl 700 using mounting hardware 520a and 520b. Escapement block 502 includes parts passageway 504 (also referred to as a “singulator”), which is configured to transport the contact from parts bowl 700 to escapement shuttle 512. Parts passageway 504 extends linearly along escapement block 502 from one end to shuttle compartment 522. Parts passageway 504 can have a “U”-shaped channel geometry large enough to accommodate a range of different part sizes without changing escapement block 502. Airgate 508 mounts over the parts passageway 504. Airgate 508 attaches an air nozzle 509 or multiple air nozzles in multiple adjustable positions which can eject a part from the parts passageway based on a commands from the controller. Airgate 508 can also feature a fiber optic sensor 511 to detect the presence or absence of parts in the escapement.

Shuttle compartment 522 is configured to receive escapement shuttle 512. Shuttle compartment 522 is shaped such that the escapement shuttle 512 translates within the shuttle compartment 522 between parts passageway 504 and parts tube mounting holes 506a and 506b to transport the contact held within the escapement shuttle 512. Parts tube mounting holes 506a and 506b are aligned about a common center axis and parallel to a single axis of parts passageway 504. Parts tube connector 202a is inserted into parts tube mounting hole 506a, and parts tube connector 202b can be inserted into parts tube mounting hole 506b. Parts tube connector 202a connects parts tube 302a to parts tube mounting hole 506a. Parts tube connector 202b connects parts tube 302b to parts tube mounting hole 506b.

Escapement shuttle 512 includes parts cavity 602, which is configured to receive a variety of parts within a specific range of sizes. For example, parts cavity 602 has the same geometry and shape as parts passageway 504. The movement of escapement shuttle 512 is restricted horizontally on the two opposite sides perpendicular to parts cavity 602 by the walls of shuttle compartment 522. On the third side, escapement shuttle 512 is restricted by the side of parts bowl 700 and on the fourth side by mounting plate 514. The movement of escapement shuttle 512 is restricted vertically by cap 510. Cap 510 further generates a seal that enables air pressure to flow through the parts tubes 302a and 302b and parts cavity 602. Mounting plate 514 includes an aperture that allows pneumatic cylinder 516 to supply a linear force to escapement shuttle 512. The linear force is used to translate escapement shuttle 512 to different positions. Pneumatic pressure actuated by pneumatic valves is supplied through pneumatic fittings 518a and 518b. In some embodiments, the pneumatic cylinder 516 is replaced with a linear actuator or mother suitable motor.

Use of pneumatics is employed in some embodiments, and alternate embodiments that employ other suitable actuation means known in the art are contemplated. Suitable actuation means are applicable to actuation of the escapement shuttle 512 and actuation of other components (e.g., shuttles, parts repository feeding, parts ejection, etc.).

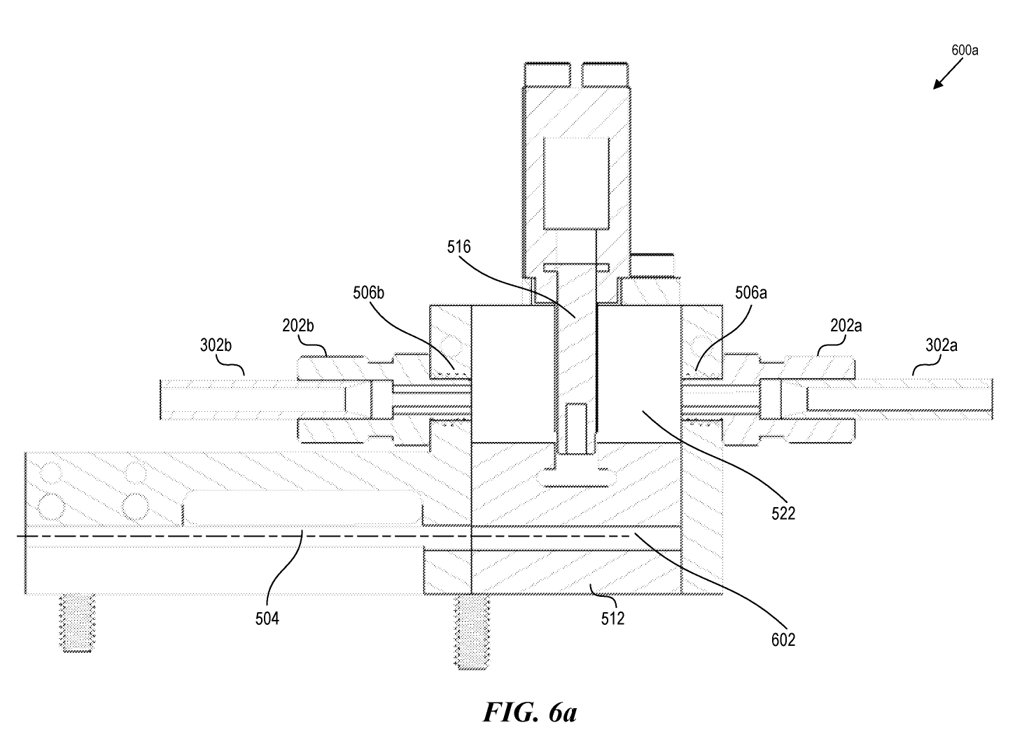

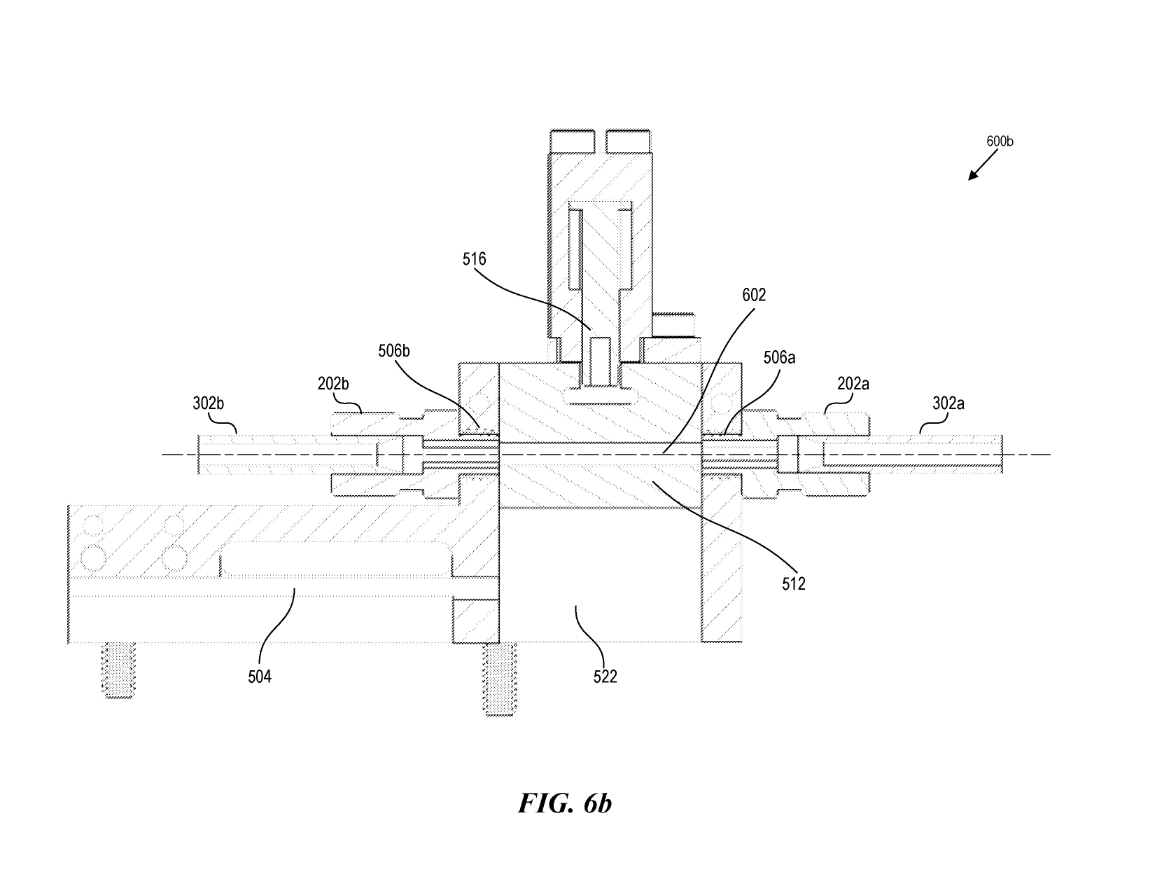

FIG. 6a illustrates a sectioned top-down view of an embodiment 600a of escapement module 104. In embodiment 600a, escapement shuttle 512 is in the first position. In the first position, the single axis of parts cavity 602 is aligned with the single axis of parts passageway 504. The first position allows the system to transfer the contact from parts passageway 504 to parts cavity 602. Escapement shuttle 512 is translated along shuttle compartment 522 using a pneumatic cylinder 516. Extending pneumatic cylinder 516 from a retracted position causes escapement shuttle 512 to translate to the first position from a second position where parts cavity 602 is aligned with parts tube mounting holes 506a and 506b, parts tube connectors 202a and 202b, and parts tubes 302a and 302b. Pneumatic cylinder 516 will translate escapement shuttle 512 with linear force actuated by a pneumatic valve which is actuated by the controller.

FIG. 6b illustrates a sectioned top-down view of an embodiment 600a of escapement module 104. In embodiment 600b, escapement shuttle 512 is in the second position. In the second position, the single axis of parts cavity 602 is aligned with the single axis of parts tube mounting holes 506a and 506b, parts tube connectors 202a and 202b, and parts tubes 302a and 302b. The second position allows the system to transfer the contact from parts cavity 602 to either parts tube 302a or parts tube 302b. Escapement shuttle 512 is translated along shuttle compartment 522 using pneumatic cylinder 516. Retracting pneumatic cylinder 516 from the extended position causes escapement shuttle 512 to translate to the second position from the first position where parts cavity 602 is aligned with parts passageway 504. Pneumatic cylinder 516 supplies a linear force to translate escapement shuttle 512 from the first position to the second position and vice versa. Pneumatic cylinder 516 is actuated by a pneumatic valve which is actuated by the controller.

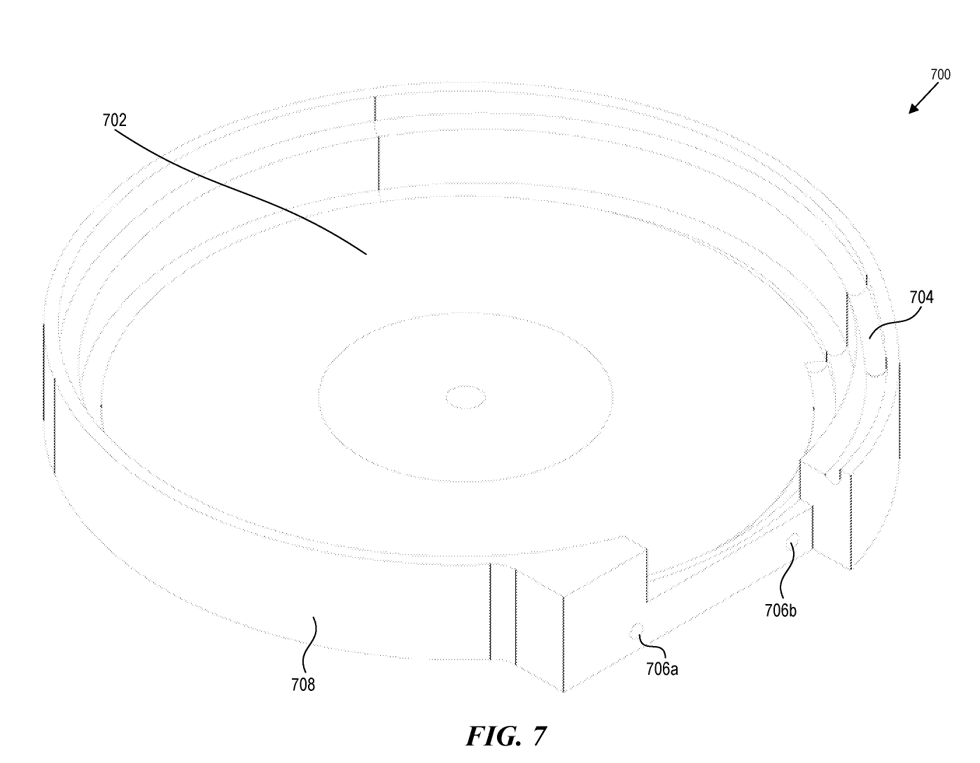

FIG. 7 illustrates an isometric view of parts bowl 700. Parts bowl 700 includes a storage compartment with circular base 702 and exterior wall 708 extending radially around the outer diameter of circular base 702. Parts bowl 700 includes parts track 704, which is configured to transport the contact from circular base 702 of the storage compartment to escapement module 104 (FIG. 1). Parts track 704 is circumscribed about an inner diameter surface of exterior wall 708 of the storage compartment. Parts track 704 extends helically around the inner diameter of exterior wall 708 from circular base 702 to where escapement module 104 is mounted. Mounting hardware 520a and 520b (FIG. 5) of escapement module 104 is configured to align with and couple to mounting holes 706a and 706b. Mounting hardware 520a couples to mounting hole 706a, and mounting hardware 520b couples to mounting hole 706b.

The parts bowl 700 is depicted for illustrative purposes of a given embodiment. Various embodiments of the system do not employ a parts bowl 700 and instead include another feeding mechanism known in the art.

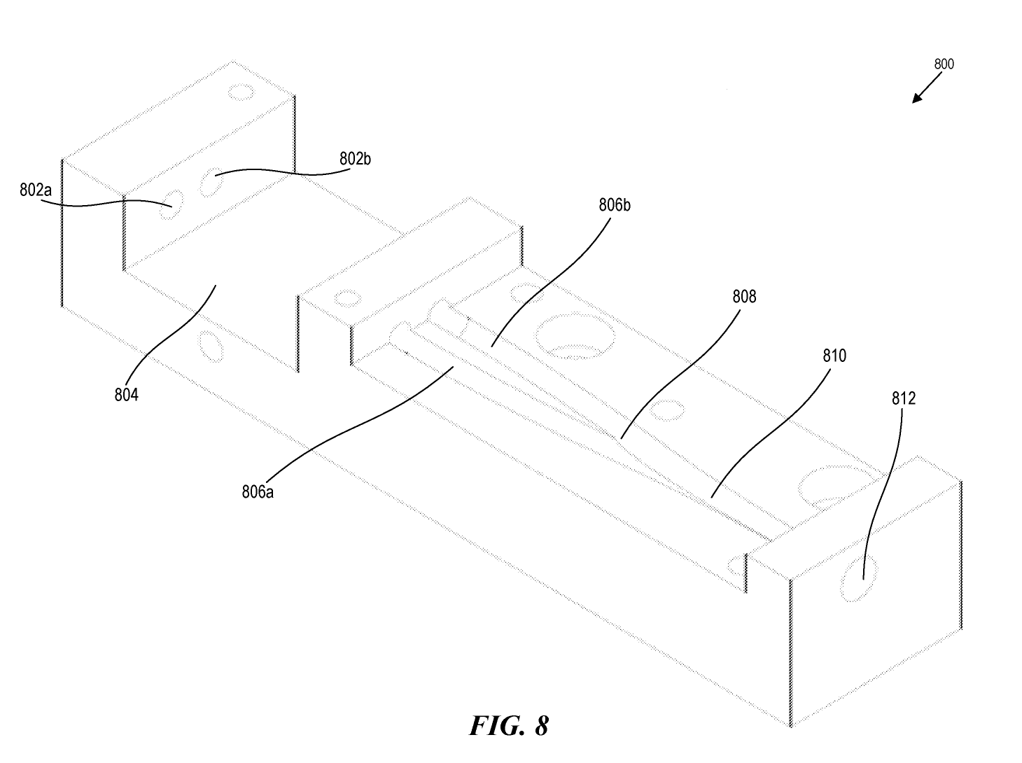

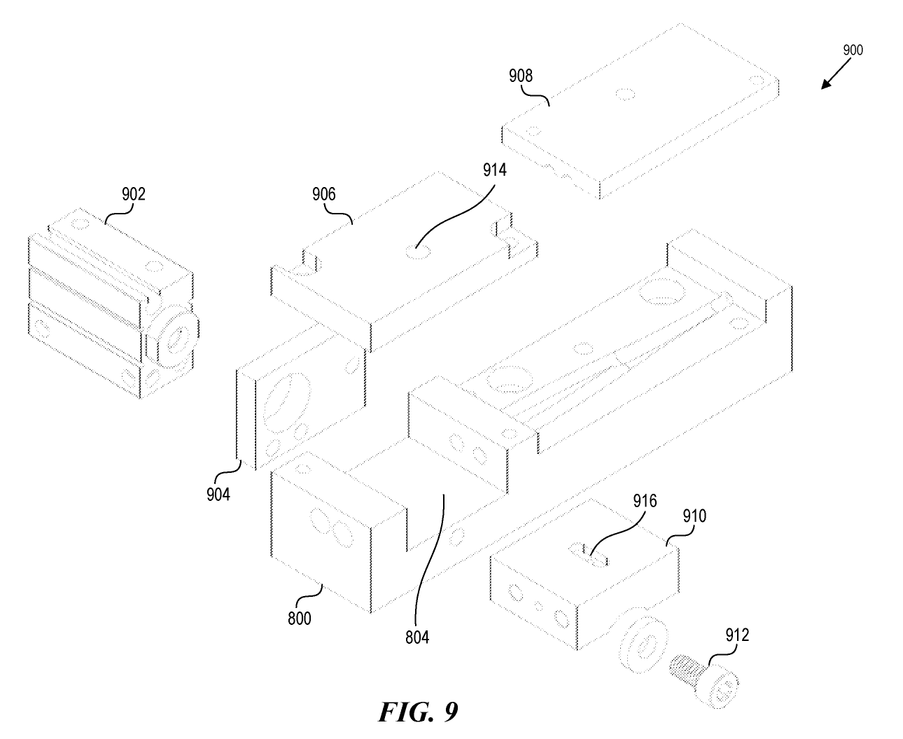

FIG. 8 illustrates an isometric view of an embodiment of receiving block 800of the twinfire module 900 (FIG. 9). Receiving block 800 includes parts tube mounting holes 802a and 802b. Parts tube mounting hole 802a is configured to couple to parts tube 302a (FIG. 3), and parts tube mounting hole 802b is configured to couple to parts tube 302b (FIG. 3). Parts tube mounting holes 802a and 802b can be configured to directly receive parts tubes 302a and 302b or be threaded to accept parts tube connectors as with parts tube mounting holes 506a and 506b (FIG. 5). Shuttle compartment 804 is configured to receive twinfire shuttle 910 (FIG. 9).

Shuttle compartment 804 is positioned between mount holes 802a and 802b and passageways 806a and 806b. A first section of passageway 806a is axially spaced and parallel to a first section of passageway 806b. The first section of passageways 806a and 806b extends from shuttle compartment 804 to a predetermined distance from merge point 808. Merge point 808 is the location where passageways 806a and 806b merge or combine into passageway 810. Passageway 810 extends from merge point 808 to parts tube mounting hole 812. Merge point 808 causes the contact to be transported to crimp head module 102 (FIG. 1) or another device in a single parts tube with the same (correct) orientation every time. For example, the geometry of receiving block 800 always causes the contact to be delivered to the crimp head module 102 with the same orientation, i.e., the wire barrel first orientation, no matter what orientation was determined by the optical sensor 106 (FIG. 1). Parts tube mounting hole 812 couples to parts tube 108 (FIG. 1) to receiving block 800.

FIG. 9 illustrates an exploded isometric view of twinfire module 900. Receiving block 800 includes cover 908 positioned over the passageways 806a, 806b, and 810 (FIG. 8). Receiving block 800 also includes shuttle compartment 804. Shuttle compartment 804 is configured to receive twinfire shuttle 910. Shuttle compartment 804 can have a squared geometry that allows twinfire shuttle 910 to translate between a first position and a second position. The two positions of the twinfire shuttle 910 alternate which passageway 806a or 806b are open to parts pathing and which parts tube 302a or 302b delivers pressurized air through the system.

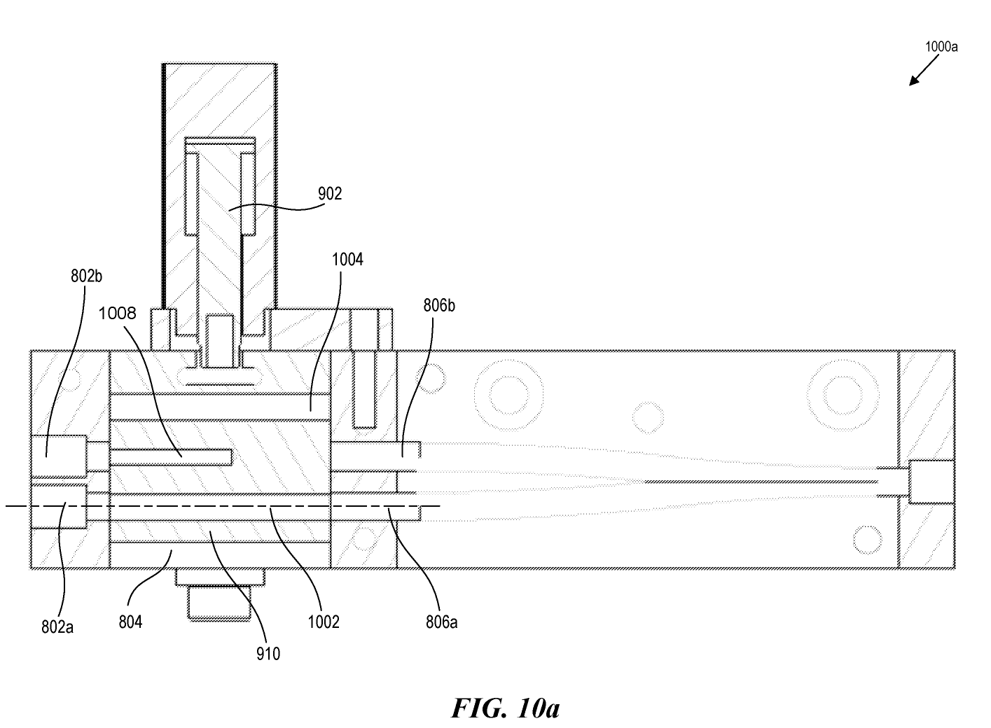

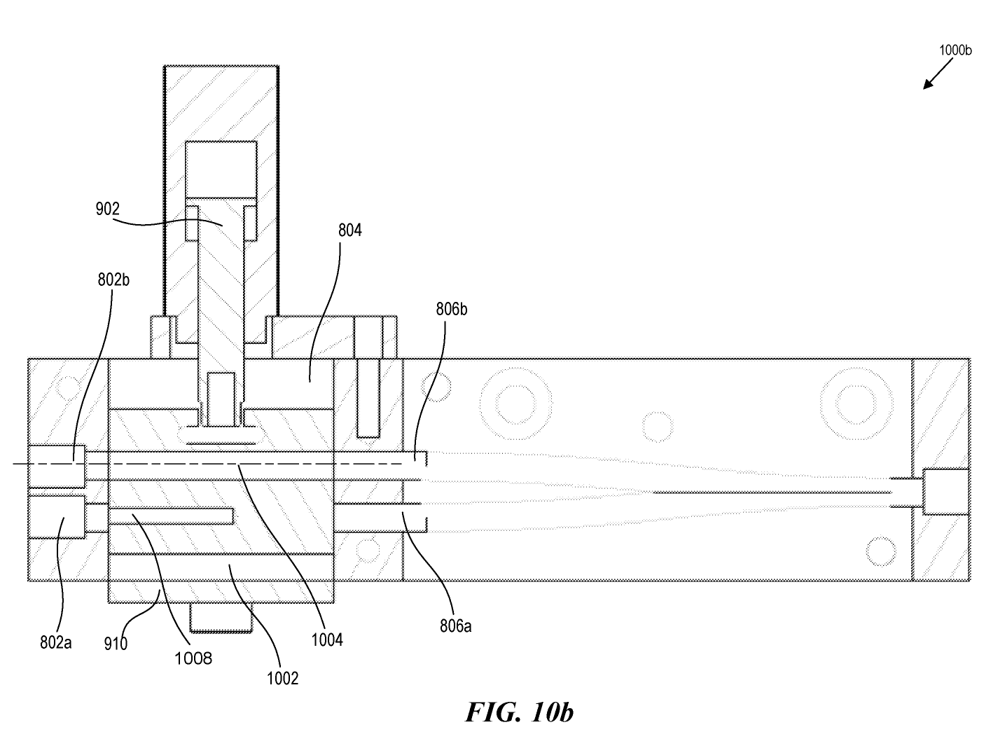

Twinfire shuttle 910 is shaped to align with and closely fit the shape of shuttle compartment 804. The position of twinfire shuttle 910 is operated based on the measured orientation of the contact. The movement of twinfire shuttle 910 is restricted horizontally on the two opposite sides perpendicular to parts channels 1002 and 1004 (FIG. 10a) by the walls of shuttle compartment 804. On the third side, twinfire shuttle 910 is restricted by hardware 912, and on the fourth side by cover 904. The movement of twinfire shuttle 910 is restricted vertically by cover 906. Cover 904 includes a port that allows pneumatic cylinder 902 to supply a linear force to twinfire shuttle 910. The linear force translates twinfire shuttle 910 from the first position to the second position and vice versa.

Cover 906 further includes a first port 914 that delivers air pressure through the twinfire shuttle 910 via an aligned port 916 to the sealed mount hole 802a or 802b (based on shuttle position). When the system fires, pneumatic force is delivered via port 914 and aligned port 916 through mount hole 802a or 802b (whichever is closed to parts delivery) through corresponding parts tube 302a or 302b and pushes a part situated in escapement shuttle 512 through the opposite parts tube 302a or 302b through the open passageway 806a or 806b. Aligned port 916 includes a slot such that regardless of the position of the twinfire shuttle 910 there is overlap with port 914.

FIG. 10a illustrates a sectioned top-down view of an embodiment 1000a of twinfire module 900. In embodiment 1000a, twinfire shuttle 910 is in the first position. In the first position, the single axis of parts channel 1002 is aligned with the single axis of parts tube mounting hole 802a and the first section of passageway 806a. The first position allows the system to transfer the contact from parts tube 302a to parts tube 108 (FIG. 1). Twinfire shuttle 910 is translated along shuttle compartment 804 using pneumatic cylinder 1006. While in the first position, air pressure is delivered through channel 1008 via port 914 and aligned port 916 (FIG. 9). The air pressure delivers pneumatic force through hole 802b and corresponding parts tube 302b.

Retracting pneumatic cylinder 902 from the extended position to a retracted position causes twinfire shuttle 910 to translate to the first position from the second position where parts channel 1004 was aligned with parts tube mounting hole 802b and the first section of passageway 806b. Pneumatic cylinder 902 extends and retracts with linear force and causes twinfire shuttle 910 to translate between positions.

FIG. 10b illustrates a sectioned top-down view of an embodiment 1000b of twinfire module 900. In embodiment 1000b, twinfire shuttle 910 is in the second position. In the second position, the single axis of parts channel 1004 is aligned with the single axis of parts tube mounting hole 802b and the first section of passageway 806b. The second position allows the system to transfer the contact from parts tube 302b to parts tube 108 (FIG. 1). Twinfire shuttle 910 is translated along shuttle compartment 804 using pneumatic cylinder 902. While in the second position, air pressure is delivered through channel 1008 via port 914 and aligned port 916 (FIG. 9). The air pressure delivers pneumatic force through hole 802a and corresponding parts tube 302a.

Extending pneumatic cylinder 902 from the retracted position to an extended position causes twinfire shuttle 910 to translate to the second position from the first position where parts channel 1002 was aligned with parts tube mounting hole 802a and the first section of passageway 806a. Pneumatic cylinder 902 extends and retracts with linear force and causes twinfire shuttle 910 to translate between positions.

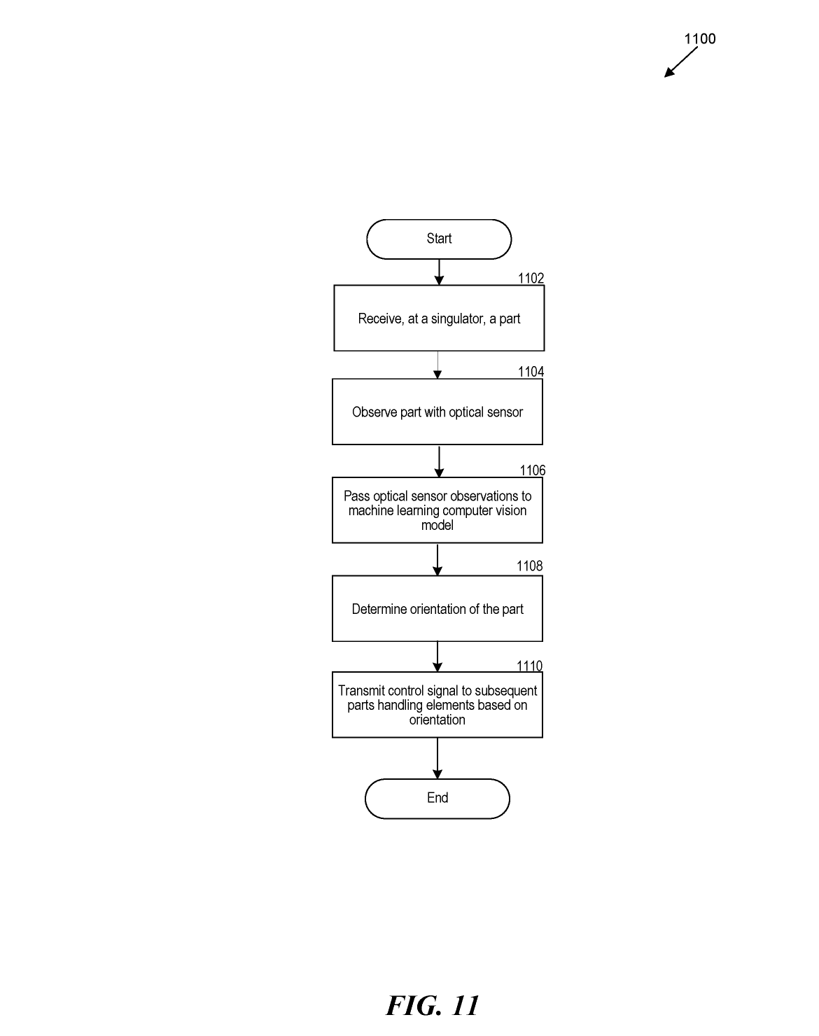

FIG. 11 illustrates a flow chart of an embodiment of parts handling of the system. In one example, the system can comprise a control system with a controller. The controller includes at least one hardware processor and at least one non-transitory memory storing instructions, which, when executed by the at least one hardware processor, cause the system to perform the process 1100.

At step 1102, the system receives, at the escapement module, an electrical contact or other part. The escapement module's singulator aligns multiple electrical contacts, seal plugs or other parts into a single-file line with adequate space between the parts in queue to prevent jamming and/or other handling and/or feeding issues. The oversized parts channel is not designed for any particular part and serves to allow a significant size range of contacts or other parts to pass through and be handled. The escapement module and associated mechanisms are modular components designed to work with a specific size range of parts and can be changed out to accommodate a different size range of parts. The singulator, parts channel, escapement shuttle's cavity, parts tubes and other features are intentionally 'oversized' vis the range of parts to be handled so as to handle a wide range of parts with a single mechanism. By so doing, a relatively small set of interchangeable modular components can handle and feed most of the parts that are employed by a given industry or use case (e.g., MILSPEC electrical contacts for the defense and aerospace industries) enabling the system to operate as a “universal” parts handling and feeding system.

At step 1104, an optical sensor, such as a camera is directed at the first part which has passed over the singulator and arrived in the escapement shuttle. In some embodiments, the optical sensor includes a light to provide consistent lightning conditions for visible light analysis, other applications may make use of polarizing filters or colored UV or infrared lights.

In step 1106, the optical sensor observations are transmitted to an ML model that performs computer vision thereon. The ML model is trained for the particular part that is actively being processed by the escapement module. Typically, contacts, seal plugs, and other parts used in manufacture of wire harnesses are sorted by parts number and only a single parts number is processed at a time. However, the escapement module and optical sensor are configured to determine orientation of a high degree of interoperability of parts and thus, in some embodiments, is enabled to determine the orientation of different parts numbers passing through the escapement module without the need to change optical sensor training programs (e.g., via a two stage computer vision process that (1) identifies part and then (2) identifies orientation of said part). Well implemented ML models can also flag incorrect parts being provisioned as well as detect debris or other obstructions on the escapement shuttle.

In step 1108, the system determines the presence or absence of a part, the orientation of the part, and whether the shuttle is clear of obstructions and can safely be moved to the second position without crashing into a part or debris via the ML model. The ML model can also be used to detect if incorrect parts have been provisioned to the machine. The training of the optical sensor is performed on a per-part basis. That is, each part that a user intended to run through the system goes through a training process. Given the limited number of orientations (e.g., 2) and limited number of variations (e.g., positioning limited by the parts passageway and/or escapement shuttle) there are comparatively few permutations to train for a single part. Based on the training, the ML model determines the presence/orientation of the observed part (e.g., for a contact wire barrel or socket first) and whether it is safe to fire the part. Trained programs may be saved to allow the operators to quickly change configurations without re-training and allow machines to ship with a large library of pre-trained programs. When paired with the correct escapement mechanism, this facilitates the machine being able to feed a range of commonly used parts without having to perform training. In step 1110, the system transmits a control signal based on the orientation of the observed contact to downstream parts delivery elements. In various embodiments, the subsequent parts delivery elements are configured based on industrial application of the system.

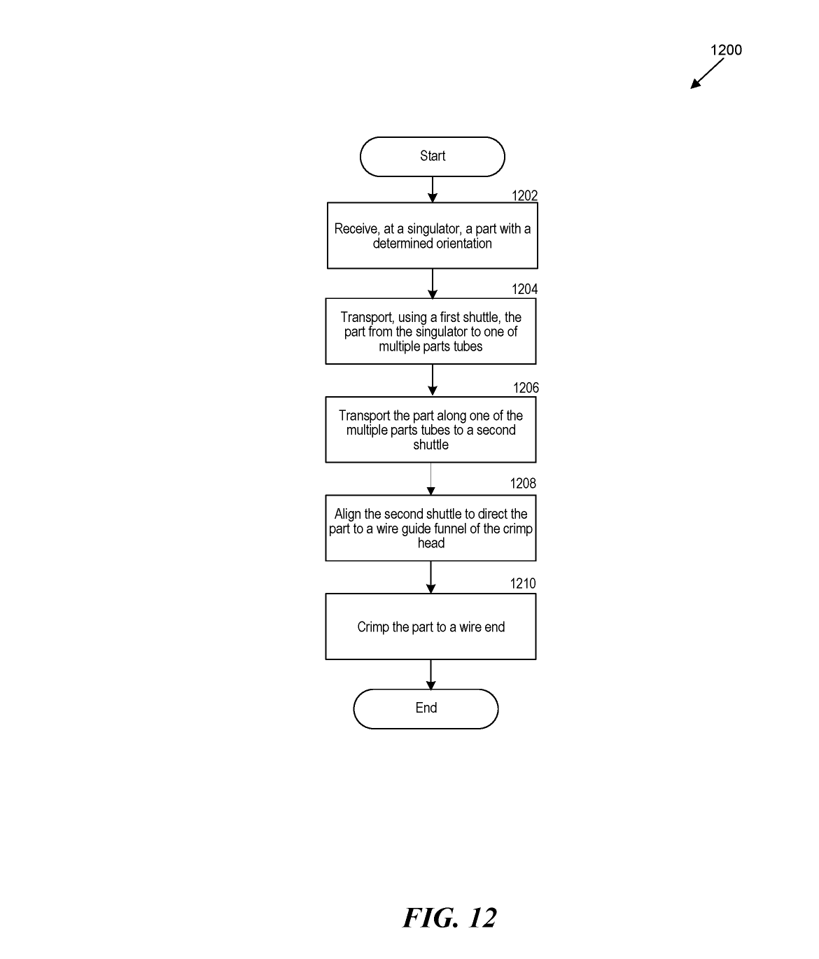

FIG. 12 illustrates a flow chart of an embodiment of parts delivery of the system for the application of wire termination. In one example, the system can comprise a control system with a controller. The controller includes at least one hardware processor and at least one non-transitory memory storing instructions, which, when executed by the at least one hardware processor, cause the system to perform the process 1200.

The escapement mechanism is fed parts (in this case, electrical contacts) from the vibratory parts bowl and mechanically aligns the contacts into a queue of separated individuated parts aligned along a single axis within the singulator portion of the Escapement module. At step 1202, the system receives, at the escapement shuttle an electrical contact and determines the part's orientation. The orientation is identified at delivery, e.g., via a ML model (see FIG. 11).

At step 1204, the system translates, using the escapement shuttle, the electrical contact from the escapement module's viewer position to one of multiple parts tubes. The multiple parts tubes are axially spaced and coaxially aligned along a shared single axis. The escapement shuttle aligns between the multiple parts tubes. In one example, the electrical contract travels over the singulator to the escapement shuttle in its resting position coaxially aligned along a single axis and adjacent the singulator, where it is observed by the optical sensor. The part's orientation having been determined, the system moves the escapement shuttle to the second position wherein the shuttle's transport cavity of the escapement shuttle is coaxially aligned with the shared single axis of the multiple parts tubes. The shuttle's movement is accomplished by linear force generated by a pneumatic cylinder attached to both the shuttle and the larger escapement mechanism.

At step 1206, the system transports the electrical contact along one of the multiple parts tubes to a twinfire shuttle housed in the twinfire module. The electrical contact is transported using pneumatic air pressure actuated by a pneumatic valve the twinfire shuttle and associated receiving block. The twinfire module is mounted to or adjacent to a crimp head module or other secondary process. The position of the twinfire shuttle controls which of the multiple parts tubes the electrical contact is transported along and which tube directs the pneumatic force. The orientation of the electrical contact determines the parts tube the electrical contact is transported along.

At step 1210, the part is delivered to the next process in the proper orientation for further processing, in this example to a crimp head for wire termination, presented with the wire barrel oriented first. Depending on the position of the twinfire shuttle, the part will be delivered via one parts tube or another. In the case of wire termination an electrical contact is presented to a crimp head. In the case of insertion into a connector, a sealing plug or electrical contact would be presented to an inserter head.

### Machine Learning Model

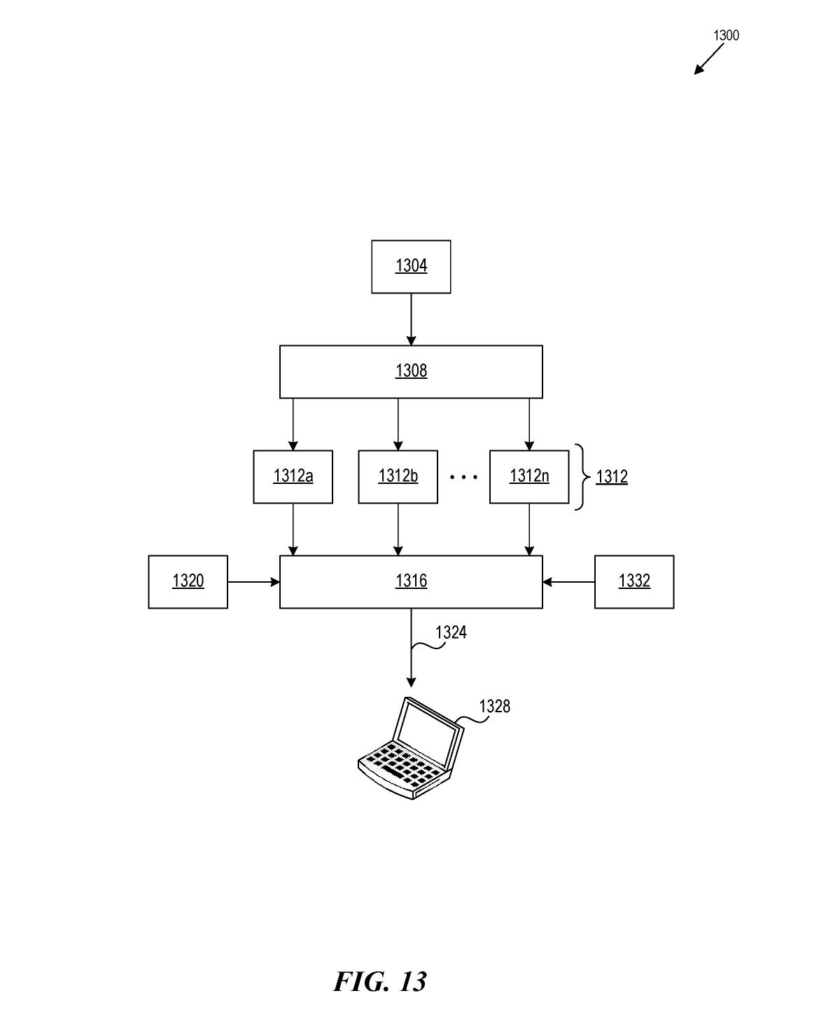

FIG. 13 is a block diagram illustrating an example ML system 1300, in accordance with one or more embodiments. Likewise, different embodiments of the ML system 1300 include different and/or additional components and are connected in different ways. The ML system 1300 is sometimes referred to as an ML module.

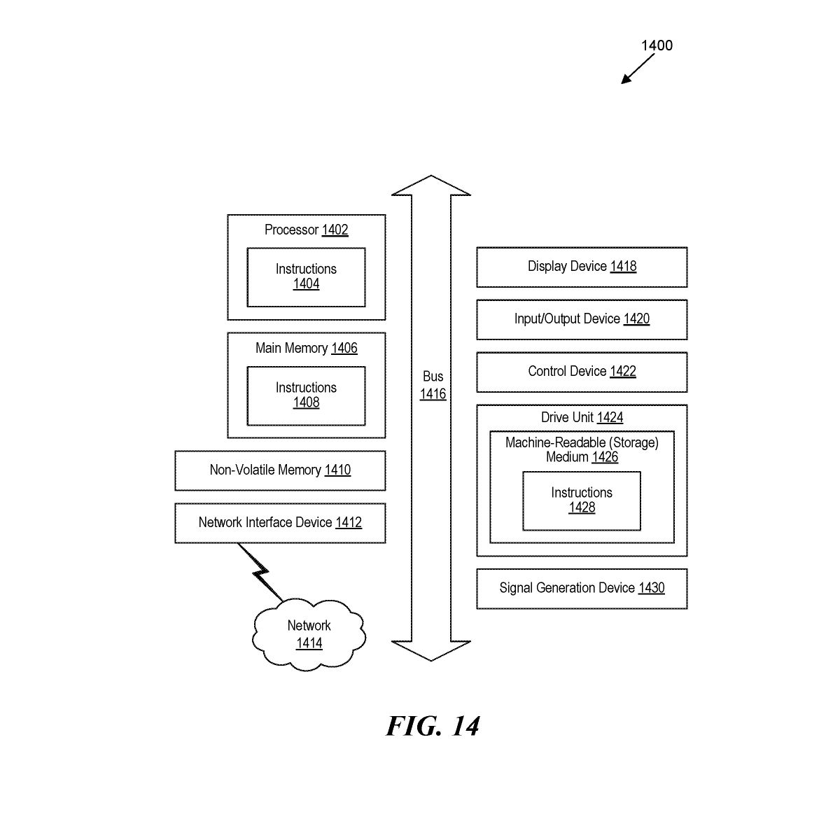

The ML system 1300 includes a feature extraction module 1308 implemented using components of the example computer system 1400 illustrated and described in more detail with reference to FIG. 14. In some embodiments, the feature extraction module 1308 extracts a feature vector 1312 from input data 1304. The feature vector 1312 includes features 1312a, 1312b, . . ., 1312n. The feature extraction module 1308 reduces the redundancy in the input data 1304, for example, repetitive data values, to transform the input data 1304 into the reduced set of features 1312, for example, features 1312a, 1312b, . . ., 1312n. The feature vector 1312 contains the relevant information from the input data 1304, such that events or data value thresholds of interest are identified by the ML model 1316 by using a reduced representation. In some example embodiments, the following dimensionality reduction techniques are used by the feature extraction module 1308: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 1316 performs deep learning (also known as deep structured learning or hierarchical learning) directly on the input data 1304 to learn data representations, as opposed to using task-specific algorithms. In deep learning, no explicit feature extraction is performed; the features 1312 are implicitly extracted by the ML system 1300. For example, the ML model 1316 uses a cascade of multiple layers of nonlinear processing units for implicit feature extraction and transformation. Each successive layer uses the output from the previous layer as input. The ML model 1316 thus learns in supervised (e.g., classification) and/or unsupervised (e.g., pattern analysis) modes. The ML model 1316 learns multiple levels of representations that correspond to different levels of abstraction, wherein the different levels form a hierarchy of concepts. The multiple levels of representation configure the ML model 1316 to differentiate features of interest from background features.

In alternative example embodiments, the ML model 1316, for example, in the form of a convolutional neural network (CNN), generates the output 1324, without the need for feature extraction, directly from the input data 1304. The output 1324 is provided to the computer device 1328. The computer device 1328 is a server, computer, tablet, smartphone, smart speaker, etc., implemented using components of the example computer system 1400 illustrated and described in more detail with reference to FIG. 14. In some embodiments, the steps performed by the ML system 1300 are stored in memory on the computer device 1328 for execution. In other embodiments, the output 1324 is displayed on an electronic display of the computer device 1328.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 1316 is a CNN that includes both convolutional layers and max pooling layers. For example, the architecture of the ML model 1316 is “fully convolutional,” which means that variable-sized sensor data vectors are fed into it. For convolutional layers, the ML model 1316 specifies a kernel size, a stride of the convolution, and an amount of zero padding applied to the input of that layer. For the pooling layers, the ML model 1316 specifies the kernel size and stride of the pooling.

In some embodiments, the ML system 1300 trains the ML model 1316, based on the training data 1320, to correlate the feature vector 1312 to expected outputs in the training data 1320. As part of the training of the ML model 1316, the ML system 1300 forms a training set of features and training labels by identifying a positive training set of features that have been determined to have a desired property in question, and, in some embodiments, forms a negative training set of features that lack the property in question.

The ML system 1300 applies ML techniques to train the ML model 1316, that when applied to the feature vector 1312, outputs indications of whether the feature vector 1312 has an associated desired property or properties, such as a probability that the feature vector 1312 has a particular Boolean property, or an estimated value of a scalar property. In embodiments, the ML system 1300 further applies dimensionality reduction (e.g., via linear discriminant analysis (LDA), PCA, or the like) to reduce the amount of data in the feature vector 1312 to a smaller, more representative set of data.

In embodiments, the ML system 1300 uses supervised ML to train the ML model 1316, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 1332 is formed of additional features, other than those in the training data 1320, which have already been determined to have or to lack the property in question. The ML system 1300 applies the trained ML model 1316 to the features of the validation set 1332 to quantify the accuracy of the ML model 1316. Common metrics applied in accuracy measurement include Precision and Recall, where Precision refers to a number of results the ML model 1316 correctly predicted out of the total it predicted, and Recall is a number of results the ML model 1316 correctly predicted out of the total number of features that had the desired property in question. In some embodiments, the ML system 1300 iteratively re-trains the ML model 1316 until the occurrence of a stopping condition, such as the accuracy measurement indication that the ML model 1316 is sufficiently accurate, or a number of training rounds having taken place. In embodiments, the validation set 1332 includes data corresponding to confirmed locations, dates, times, activities, or combinations thereof. This allows the detected values to be validated using the validation set 1332. The validation set 1332 is generated based on the analysis to be performed.

### Computer System

FIG. 14 is a block diagram that illustrates an example of a computer system 1400 in which at least some operations described herein can be implemented. As shown, the computer system 1400 can include: one or more processors 1402, main memory 1406, non-volatile memory 1410, a network interface device 1412, a video display device 1418, an input/output device 1420, a control device 1422 (e.g., keyboard and pointing device), a drive unit 1424 that includes a machine-readable (storage) medium 1426, and a signal generation device 1430 that are communicatively connected to a bus 1416. The bus 1416 represents one or more physical buses and/or point-to-point connections that are connected by appropriate bridges, adapters, or controllers. Various common components (e.g., cache memory) are omitted from FIG. 14 for brevity. Instead, the computer system 1400 is intended to illustrate a hardware device on which components illustrated or described relative to the examples of the figures and any other components described in this specification can be implemented.

The computer system 1400 can take any suitable physical form. For example, the computing system 1400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1400. In some implementations, the computer system 1400 can be an embedded computer system, a system-on-chip (SOC), a single-board computer system (SBC), or a distributed system such as a mesh of computer systems, or it can include one or more cloud components in one or more networks. Where appropriate, one or more computer systems 1400 can perform operations in real time, in near real time, or in batch mode.

The network interface device 1412 enables the computing system 1400 to mediate data in a network 1414 with an entity that is external to the computing system 1400 through any communication protocol supported by the computing system 1400 and the external entity. Examples of the network interface device 1412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1406, non-volatile memory 1410, machine-readable medium 1426) can be local, remote, or distributed. Although shown as a single medium, the machine-readable medium 1426 can include multiple media (e.g., a centralized/distributed database and/or associated caches and servers) that store one or more sets of instructions 1428. The machine-readable medium 1426 can include any medium that is capable of storing, encoding, or carrying a set of instructions for execution by the computing system 1400. The machine-readable medium 1426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1404, 1408, 1428) set at various times in various memory and storage devices in computing device(s). When read and executed by the processor 1402, the instruction(s) cause the computing system 1400 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A system comprising:
an escapement module including:
a parts passageway extending linearly from a receiving end of the escapement module to a shuttle compartment;
the shuttle compartment including a set of parts tube mounting holes axially offset from and parallel to the parts passageway; and
a shuttle located inside the shuttle compartment and having a parts cavity parallel to the parts passageway, wherein the shuttle is configured to translate within the shuttle compartment;
an optical sensor directed at least one of the shuttle or the parts passageway, wherein the optical sensor is configured to measure an orientation of a subject part in an observed area; and
multiple parts tubes, each having a respective end coaxially aligned and contiguous to one of a given parts tube mounting hole of the set of parts tube mounting holes, wherein pneumatic pressure transports the subject part through one of the multiple parts tubes to a different location, and wherein a first parts tube of the multiple parts tubes transports the subject part when the subject part has a first orientation, and a second parts tube of the multiple parts tubes transports the subject part when the subject part has a second orientation.

2. The system of claim 1, further comprises:
an airgate coupled to the escapement module, wherein the airgate is adjustable for positioning and configured to remove a part from the escapement module based on a measurement from the optical sensor or commands from a controller.

3. The system of claim 1, further comprising:
a parts bowl configured to store multiple loose parts including:
a storage compartment; and
a parts track configured to receive the multiple loose parts from the storage compartment and direct the multiple loose parts to the escapement module, wherein the parts passageway is aligned and contiguous to a supply end of the parts track.

4. The system of claim 1, wherein the optical sensor includes a camera.

5. The system of claim 1, wherein the optical sensor includes a machine learning model to measure the orientation of the subject part.

6. The system of claim 1 further comprising:
a pneumatic module,
wherein the pneumatic module supplies a first movement force used to translate the shuttle to a different position and a second movement force to transport the subject part along a determined parts tube based on the orientation of the subject part.

7. The system of claim 1, wherein the shuttle includes:
a first position, wherein in the first position, the parts cavity of the shuttle is coaxially aligned with the parts passageway; and
a second position, wherein in the second position, the parts cavity of the shuttle is coaxially aligned with the multiple parts tubes.

8. The system of claim 1, further comprising:
a parts receiving block comprising:
a second shuttle compartment including a second set of multiple parts tube mounting holes configured to connect to a corresponding supply end of the multiple parts tubes; and
a forked parts passageway including multiple passageways merging into a singular passageway, extending from the second shuttle compartment to a parts feeding tube, and each of the multiple passageways is aligned with one of the multiple parts tubes;
a second shuttle located inside the second shuttle compartment and having multiple parts channels parallel to the second set of multiple parts tube mounting holes, wherein the second shuttle is configured to axially translate within the second shuttle compartment; and
a parts delivery tube to transmit the subject part to an auxiliary applicator.

9. The system of claim 8, wherein the second shuttle includes:
a first position, wherein in the first position, the second shuttle aligns the first parts tube of the multiple parts tubes with the forked parts passageway and a pressure delivery port is coaxially aligned with the second parts tube of the multiple parts tubes; and
a second position, wherein in the second position, the second shuttle aligns the second parts tube with the forked parts passageway and the pressure delivery port is coaxially aligned with the first parts tube,
wherein the pressure delivery port is configured to deliver pneumatic force through a respective parts tube and deliver the subject part via the other corresponding parts tube.

10. The system of claim 9 further comprising:
a pneumatic module configured to supply pneumatics to the parts receiving block,
wherein the pneumatic module supplies a first movement force used to translate the second shuttle between the first position and the second position.

11. A control system for manufacture of wire harnesses or electrical connectors comprising:
at least one hardware processor; and
at least one non-transitory memory storing instructions, which when executed by the at least one hardware processor, cause the control system to:
receive, at an escapement module, a part;
determine an orientation of the part based on data observed by an optical sensor;
transport, via a first shuttle, the part from an optical sensor viewing position to a second position aligned with at least one of multiple parts tubes, wherein the multiple parts tubes are coaxially aligned along a first axis;
transport the part along one of the multiple parts tubes to a second shuttle, wherein the part is transported via pneumatic pressure generated by a pneumatic module,
wherein a position of the second shuttle controls which of the multiple parts tubes the part is transported along,
wherein the control system causes positioning of the second shuttle based on the orientation of the part; and
align the second shuttle based on the orientation of the part to direct the part to a subsequent process.

12. The control system of claim 11, wherein the optical sensor uses a machine learning model to measure the orientation of the part.

13. The control system of claim 11 further caused to:
remove, using an airgate, the part from the escapement module,
wherein the part is removed based on the orientation determined from the optical sensor.

14. The control system of claim 11, wherein the optical sensor includes a camera.

15. A system comprising:
a parts storage receptacle configured to store multiple loose parts;
an escapement module tangentially mounted to an outer diameter surface of an exterior wall of the parts storage receptacle, including:
a parts passageway in line with and extending from the parts storage receptacle;
a first shuttle compartment including a first set of multiple parts tube mounting holes axially offset from and parallel to the parts passageway; and
a first shuttle located inside the first shuttle compartment and having a parts cavity parallel to the parts passageway, wherein the first shuttle is configured to axially translate within the first shuttle compartment between alignment with the parts passageway and alignment with the first set of multiple parts tube mounting holes;
an optical sensor directed at least one of the first shuttle or the parts passageway, wherein the optical sensor is configured to measure an orientation of a subject part in an observed area;
multiple parts tubes, each having a receiving end coaxially aligned and contiguous to a corresponding parts tube mounting hole of the first set of multiple parts tube mounting holes of the first shuttle compartment,
wherein pneumatic pressure transports the subject part through one of the multiple parts tubes to a subsequent process,
and wherein the subject part is transported via a first parts tube of the multiple parts tubes when the subject part has a first orientation and the subject part is transported via a second parts tube of the multiple parts tubes when the subject part has a second orientation;
a parts receiving block comprising:
a second shuttle compartment including a second set of multiple parts tube mounting holes configured to connect to a corresponding supply end of the multiple parts tubes;
a forked parts passageway including multiple passageways merging into a singular passageway, extending from the second shuttle compartment to a parts feeding tube, and each of the multiple passageways is aligned with one of the multiple parts tubes;
a second shuttle located inside the second shuttle compartment and having multiple parts channels parallel to the second set of multiple parts tube mounting holes, wherein the second shuttle is configured to axially translate within the second shuttle compartment; and
a parts delivery tube to transmit the subject part to an auxiliary applicator; and
a controller having at least one hardware processor and at least one non-transitory memory storing instructions,
wherein the controller is configured to determine, based on the measured orientation of the subject part, which parts tube of the multiple parts tubes to transport the subject part along.

16. The system of claim 15, wherein the first shuttle includes:
a first position, wherein in the first position, the parts cavity of the first shuttle is coaxially aligned with the parts passageway; and
a second position, wherein in the second position, the parts cavity of the first shuttle is coaxially aligned with the multiple parts tubes.

17. The system of claim 15, wherein the optical sensor uses a machine learning model to measure the orientation of the subject part.

18. The system of claim 15 wherein the second shuttle includes:
a first position, wherein in the first position, the second shuttle aligns the first parts tube of the multiple parts tubes with the forked parts passageway and a pressure delivery port is coaxially aligned with the second parts tube of the multiple parts tubes; and
a second position, wherein in the second position, the second shuttle aligns the second parts tube with the forked parts passageway and the pressure delivery port is coaxially aligned with the first parts tube,
wherein the pressure delivery port is configured to deliver pneumatic force through a respective parts tube and deliver the subject part via the other corresponding parts tube.

19. The system of claim 15, wherein the escapement module further comprises:
an airgate coupled to the escapement module, wherein the airgate is adjustable for positioning and configured to remove a part from the escapement module based on a measurement from the optical sensor or commands from the controller.

20. The system of claim 17, wherein the optical sensor includes a camera.

21. The system of claim 17, wherein the parts storage receptacle comprises:
a storage compartment; and
a parts track configured to receive the multiple loose parts from the storage compartment and direct the multiple loose parts to the escapement module, wherein the parts passageway is aligned and contiguous to a supply end of the parts track.
